(19) United States
(12) Patent Application Publication
(10) Pub. No.: US 2026/0356343 A1
(43) Pub. Date: Nov. 12, 2026

(54) Ventilation Device and Brake System

(71) Applicant: KNORR-BREMSE Systeme fuer Nutzfahrzeuge GmbH, Muenchen (DE)

(72) Inventors: Karsten SCHNITTGER, Muenchen (DE); Christian KUHLEN, Aschheim (DE)

(21) Appl. No.: 19/126,423

(22) PCT Filed: Oct. 24, 2023
(86) PCT No.: PCT/EP2023/079554

§ 371 Date: May 1, 2025

(30) Foreign Application Priority Data
Nov. 2, 2022 (DE) 10 2022 128 937.0

(51) Int. Cl. B60T 17/22; B60T 17/00

(52) U.S. Cl. CPC B60T 17/221; B60T 17/004

(57) ABSTRACT

A ventilation device for use with at least one valve device or a plurality of valve units, includes at least one air chamber element, an outflow section, and at least one ventilation channel for forming a fluidic connection between the exterior of the ventilation device and the at least one air chamber element. The first ventilation channel has at least one first and/or one second opening, wherein the first ventilation channel includes at least one primary labyrinth element and/or at least one secondary labyrinth element such that at least one deflection point is formed along the fluidic connection between the exterior of the ventilation device and the at least one air chamber element. A brake system, in particular for trucks, has such a ventilation device.

### BACKGROUND AND SUMMARY

The present invention relates to a ventilation device, in particular for use with at least one valve unit or a plurality of valve units, and to a brake system comprising such a ventilation device.

Trucks are usually equipped with a pneumatic brake system. Device units of such a brake system often use pneumatic valves that vent a volume flow to the outside or to an external side, and thus to the surrounding atmosphere, or have various active surfaces that must be connected to ambient pressure.

In most cases, valves vent a volume flow to the outside in one of their switching positions. Valves can have internal active surfaces that should be exposed to an ambient pressure level as constantly as possible. Such spaces, for example below a piston with a spring arranged in it, must therefore always have an open connection to the outside and are referred to as “breathing spaces”.

The valves are usually arranged and aligned vertically, so that one hole per valve pointing downwards, i.e., in the direction of gravity, is ideal for ventilation.

However, these ventilation holes have little or no protection against water ingress, e.g., when cleaning with a high-pressure cleaner.

Furthermore, in the case of complex device units of a truck brake system, it is not always possible for all valves to be arranged in this form, i.e., in a vertical direction, in order to align their ventilation holes accordingly. In this case, the moisture or liquid that has penetrated cannot, or cannot completely, drain away under the force of gravity. Especially when the temperature drops below freezing, the remaining water in the valves may freeze and block them.

It is the object of the present invention to develop a ventilation device of the type mentioned at the outset in an advantageous manner, in particular in such a way that the penetration of moisture or liquids into the ventilation device can be at least substantially prevented or counteracted and the outflow of penetrated moisture or liquid can be optimized, preferably in that a fluid connection prevents or reduces direct, immediate penetration of a water jet or the like by means of deflection points, so that a ventilation function for a plurality of device units, such as valves, can be ensured. It is a further object of the present invention to provide a brake system comprising such a ventilation device.

This object is achieved in accordance with the invention by a ventilation device and by a brake system having the features of the independent claims. Further advantageous embodiments are specified in the dependent claims.

It is then provided that a ventilation device, in particular for use with at least one valve unit or a plurality of valve units, is formed with at least one air chamber element, at least one outflow portion and at least one first ventilation channel, for forming a fluid connection between an outside of the ventilation device and the at least one air chamber element, wherein the outflow portion provides the fluid connection between the air chamber element and the at least one first ventilation channel and is formed at least partially in the form of a riser channel. The first ventilation channel has at least one first and/or one second opening. The first ventilation channel is formed with at least one primary labyrinth element and/or at least one secondary labyrinth element, wherein the at least one primary and/or secondary labyrinth element are/is provided in such a way that in each case at least one deflection point is formed along the fluid connection between an outer side of the ventilation device and the at least one air chamber element, in particular via the first and/or second opening.

The invention is based on the basic idea that a ventilation system with a splash guard can be provided, in particular a common splash guard for several (horizontally stacked) valves. In particular, the ventilation device should utilize the principle of a (common) ventilation chamber/a (common) air chamber element with an outflow portion arranged (vertically) at the bottom, which opens into a ventilation channel with openings and with labyrinth elements formed/arranged in each case in the region of the openings.

Furthermore, in each case at least one deflection point can be provided on the basis of the design and arrangement of the labyrinth elements, so that penetration of moisture or liquid in the direction of a first longitudinal axis of the first ventilation channel can be prevented and/or reduced. Rather, the arrangement and design of the labyrinth elements is such that, for example, a jet of water is deflected to enter the first ventilation channel. The deflection or breaking up or redirection of the water jet means that a deep penetration of moisture/liquid into the at least one air chamber element can be at least substantially prevented and/or reduced.

In addition, the design of the outflow portion in particular at a lower end of the air chamber element and of the ventilation channel with a first and/or second opening makes it possible to both facilitate the outflow of moisture/liquid and to at least substantially prevent or counteract a rise of liquid along the first ventilation channel and/or along the outflow portion into the air chamber element.

The arrangement of the outflow portion at a preferably (vertically) lower position of the air chamber element (based on the installed state, vehicle stands on a horizontal plane) is to be understood in the sense of the present invention in particular with regard to the appropriate use and alignment of the ventilation device or a corresponding brake system. Moisture or liquid can escape or flow out of the air chamber element via the outflow portion due to gravity.

Since the outflow portion is in the form of a riser channel or riser region at least partially or in sections, the penetration of moisture, that has already penetrated, into the air chamber element is largely prevented or counteracted. In particular, a preferred combination of the labyrinth element(s) and the outflow portion with the function of a riser channel/portion can counteract the penetration of moisture or prevent such penetration.

The ventilation(s), e.g., of a plurality of valves, can take place via a common air chamber element of the ventilation device, which is formed by the ventilation device. This air chamber element, as a common space, is connected at a position vertically below the valves to at least one preferably downward and/or sideways facing outflow portion to allow ventilation outward/to an outside of the ventilation device.

Ventilation can be a so-called secondary bleeding, i.e., the bleeding of valves that only need to bleed a small volume flow, e.g., solenoid valves. Furthermore, bleeding can also be understood as the connection of “breathing spaces”, such as spring spaces or the like, to the (atmospheric) ambient pressure.

For the purposes of the present invention, a fluid connection means in particular a connection for bleeding. Thus, a fluid connection between the air chamber element and the first/second opening of the first ventilation channel, and along the respective labyrinth elements, can ensure that bleeding of, for example, a plurality of valves connected to the air chamber element can be expediently performed.

The openings of the at least one first ventilation channel allow moisture/liquid that has penetrated to flow out and/or at least substantially prevent moisture/liquid from penetrating into the air chamber element, in particular by (at least to the greatest possible extent) avoiding back pressure within the at least one first ventilation channel and/or the outflow portion.

The openings can preferably be formed at opposite ends of the first ventilation channel. Alternatively, the first/second openings can be formed along the first ventilation channel.

Since the present invention makes it possible, in particular by means of the labyrinth elements and the openings of the ventilation channels, to provide both a splash guard and a drainage of penetrated liquid, in particular due to the avoidance or reduction of a back pressure, the fluid connection from the air chamber element to the atmospheric outside of the ventilation device can also be appropriately ensured.

For the purposes of the present invention, an outflow portion can in particular be an outflow opening, an outflow channel and/or the like, so that a fluid connection can be provided between the air chamber element and the first ventilation channel. According to the invention, the outflow portion is preferably arranged or formed at a lower end of the air chamber element.

A labyrinth element can for the purposes of the present invention be understood as a portion of a fluid connection which provides at least one deflection point, preferably a plurality of deflection points. Accordingly, the fluid connection can have, for example, a plurality of angled portions, preferably angled portions in a range of from 1 to 90°, along a labyrinth element.

The fluid connection does not run solely/exclusively in the direction of the (first) longitudinal axis of the (first) ventilation channel or of the outflow portion, in particular of an outflow channel. A splash guard can thus be provided on the basis of the labyrinth elements.

At least in each case one deflection point is preferably provided by means of the labyrinth elements in such a way that penetration of dirt, liquids such as water and the like can be prevented or reduced.

In particular, for example, a high-pressure water jet cannot penetrate directly into the ventilation channel, but rather is at least substantially deflected or split on the basis of the structural arrangement and design of the ventilation channels with the labyrinth elements within the ventilation device.

Furthermore, the first ventilation channel can have a continuous or variable cross-section along its first longitudinal axis. The openings of the first ventilation channel preferably have the same cross-sections.

In order to provide a splash guard for the fluid connection, the labyrinth elements are in each case formed with at least one deflection point. In this way, a linear inflow/penetration of liquid into the ventilation channel in the direction of the associated longitudinal axis alone can be avoided.

Furthermore, it may be provided that the first ventilation channel opens into the outflow portion along its first and/or second opening and the first and/or second labyrinth element, in particular along the first opening and the first and also second labyrinth element and/or along the second opening and also the first labyrinth element and/or second labyrinth element.

Furthermore, it is contemplated that at least one second ventilation channel is provided with a first and/or second opening, wherein the first and second ventilation channels are preferably arranged on opposite end sides of the outflow portion, in particular of an outflow channel of the outflow portion, and wherein the second ventilation channel is formed with at least one primary and/or at least one secondary labyrinth element. As for the first ventilation channel, the first opening and/or the second opening can preferably be formed at opposite ends of the second ventilation channel. Alternatively, the first and/or second opening can be formed along the second ventilation channel.

In particular, the splash guard can be further optimized and supplemented by arranging or forming several ventilation channels in such a way that the fluid connection between the outside of the ventilation device and the air chamber element has several deflection points, which are formed in particular by the various labyrinth elements in combination with the respectively assigned openings of the ventilation channels.

The first and second ventilation channels can be formed symmetrically or asymmetrically to one another along the ventilation device.

Furthermore, it may be provided that in each case no labyrinth element is formed in the region of the second opening(s). This enables a more variable design of the ventilation channels or of the fluid connection, wherein the lack of a labyrinth element in each case in the region of the second opening means that there is no, at least no significant, disadvantage in terms of preventing the ingress of moisture/liquid.

Alternatively, a second labyrinth element can in each case be formed in the region of the second opening of the first and/or second ventilation channel.

The first and second ventilation channels, designed in the form of a series connection with the outflow portion, can prevent or reduce the ingress of moisture or liquid.

It may also be provided that the primary and/or secondary labyrinth element in each case form at least one deflection point along the fluid connection between the outer side of the ventilation device and the at least one air chamber element.

This prevents or counteracts the ingress of moisture/liquid in the direction of the longitudinal axis of the respective ventilation channel. In particular, by forming a plurality of deflection points, a splash guard function can be optimized.

It is also possible for the ventilation device to be designed in one or more parts, in particular with a first side part and a cover element or with corresponding first and second side parts and a sealing element arranged between the several parts.

Accordingly, the ventilation device can have a first side part in the form of a structured main body with, among other things, the air chamber element, as well as an unstructured cover element for closing the structures of the first side part.

Alternatively, the ventilation device can be designed with a first side part and a corresponding second side part, wherein the first and second side parts are each designed as structured side parts. The two side parts can have symmetrical structures or asymmetrical structures.

In this way, among other things, the air chamber element, the outflow portion and/or the first/second ventilation channel can be formed symmetrically divided into the two side parts, or divided asymmetrically, e.g., in that the air chamber element is formed at least primarily in the first side part and/or the first ventilation channel is formed at least primarily in the second side part.

With the optional sealing element between the two components of the ventilation device, i.e., between the first side part and the cover element or between the first and second side part, the air volume must be compressed when water enters the common space sealed at the top in order to reach the valves or the structures to be ventilated.

In addition to a splash guard function, in particular by means of the labyrinth elements, and a bleeding or drainage function, in particular by means of the openings of the ventilation channels, a fluid-static/dynamic resistance against the penetration of liquid into the ventilation device is thus provided.

Furthermore, it may be provided that the at least one outflow portion is formed at a lower end of the air chamber element in the vertical direction. Furthermore, it is contemplated that the at least one outflow portion is designed as at least one outflow opening or as at least one outflow opening in combination with at least one outflow channel to provide a fluid connection between the air chamber element and the at least one first ventilation channel.

Preferably, the outflow portion is arranged opposite or along the air chamber element in such a way that moisture or liquid can escape or flow away in the direction of the force of gravity.

Furthermore, the outflow portion can be designed as an outflow opening in conjunction with an outflow channel, preferably in the sense of a rising channel. Penetrating moisture or liquid, such as water, must therefore rise along the outflow portion against the force of gravity in order to reach the valves or the structures to be ventilated.

It is also contemplated that the ventilation device is designed to accommodate and bleed several valves in fluid connection with the air chamber element, wherein a ventilation region is preferably formed for each of the plurality of valves along the air chamber element.

In this way, a central bleeding can be provided for several structures to be ventilated, such as valves. The bleeding infrastructure according to the invention can be easily adapted to the number of valves or structures to be ventilated by enlarging or reducing the size of the air chamber element in particular.

In this sense, the air chamber element represents a common space provided by the ventilation device, for example by the first and second side parts in combination with a sealing element arranged therebetween.

It is furthermore contemplated that the outflow portion is provided with at least one outflow channel and at least one outflow opening, for forming a fluid connection between the outflow channel and the air chamber element, wherein the air chamber element is formed with at least one ventilation region, and wherein a (first) vertical spacing between an access region of the outflow opening, in particular on a side of the outflow opening remote from the air chamber element, and an access region of the outflow channel, in particular of the access point situated furthest away on a side of the outflow channel remote from the air chamber element, is smaller than a (second) vertical spacing between an access region of the outflow opening, in particular on a side of the outflow opening remote from the air chamber element, and the closest ventilation region. Since the vertical spacing along the outflow portion, preferably the vertical direction of the outflow portion formed at least partially as a riser channel, is smaller than the vertical spacing from the closest ventilation region along the air chamber element, penetration of moisture or water can advantageously be counteracted or prevented. In particular, the (second) vertical spacing between the access region of the outflow opening and the closest ventilation region can be several times larger than the (first) vertical spacing between the access region of the outflow opening and the access region of the outflow channel.

According to a further subsidiary aspect, the present invention relates to a brake system, in particular for trucks, comprising at least one ventilation device according to the invention.

All the structural and functional features associated with the ventilation device according to the invention described above and its possible embodiments can also be provided alone or in combination in the brake system according to the invention and the associated advantages can be achieved.

Further details and advantages of the invention will now be discussed in more detail on the basis of the exemplary embodiments illustrated in the drawings.

### BRIEF DESCRIPTION OF THE DRAWINGS

FIG. 1 is a perspective view of a first exemplary embodiment of a ventilation device;

FIG. 2 is a perspective view of a second exemplary embodiment of a ventilation device; and

FIG. 3 is a perspective view of a third exemplary embodiment of a ventilation device according to FIGS. 1 and 2.

### DETAILED DESCRIPTION OF THE DRAWINGS

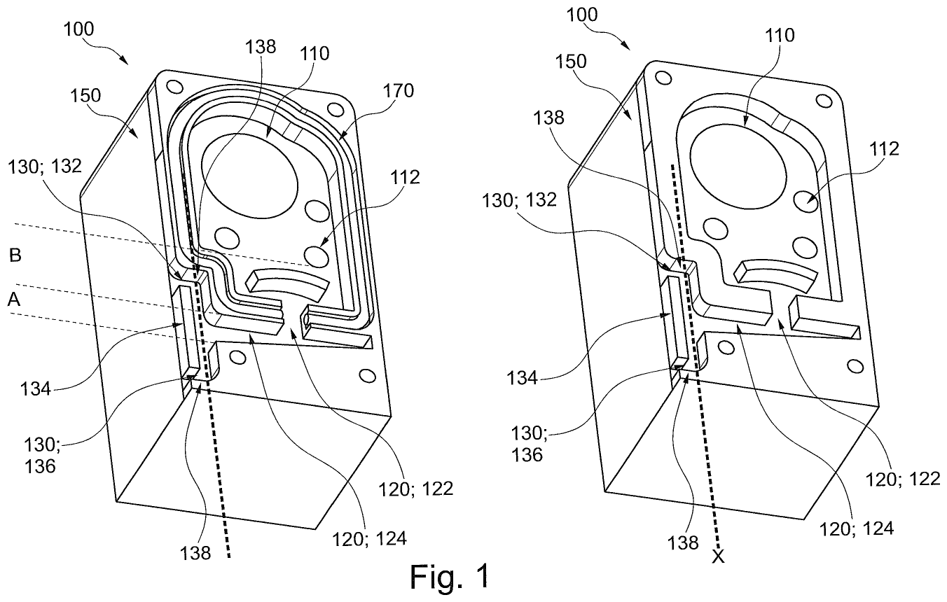

FIG. 1 shows a perspective view of a first exemplary embodiment of a ventilation device 100.

According to the first exemplary embodiment, the ventilation device 100 is designed with a first side part 150.

The side part 150 can have a sealing element 170 (see left-hand illustration in FIG. 1) or can be designed without a sealing element 170 (see right-hand illustration in FIG. 1).

The ventilation device 100 further comprises an air chamber element 110, an outflow portion 120 and at least one first ventilation channel 130.

The air chamber element 110 can be designed in such a way that bleeding can be provided for several valves, several device units or the like. In particular, the first side part 150 can have a plurality of receptacles for valves, device units or the like in the region of the air chamber element 110.

A plurality of ventilation regions 112 can preferably be formed along the air chamber element 110, for ventilating a plurality of valves or the like.

According to FIG. 1, the outflow portion 120 can be formed with an outflow opening 122, which can merge into an outflow channel 124.

The outflow portion 120, in particular the outflow opening 122, can be formed on a lower side (in the vertical direction) of the air chamber element 110 as shown in FIG. 1.

In particular, in the context of an appropriate use, the outflow portion 120 can be formed on a vertically lower side of the air chamber element 110 in order to allow moisture/liquid to run out of the air chamber element 110 in the direction of the acting force of gravity or to counteract the penetration of moisture/liquid.

The outflow portion, in particular the outflow channel 124 and/or the outflow opening 122, can be designed in the sense of a riser channel or perform such a riser channel function at least partially or in sections.

According to FIG. 1, the outflow channel 124 may extend in a substantially horizontal direction and provide a fluid connection via the outflow opening 122 to the air chamber element 110.

According to FIG. 1, the outflow channel 124 can have a tapered or changing cross-section, in particular so that a drainage of moisture/liquid can be facilitated and/or a penetration of moisture/liquid can be at least substantially prevented or counteracted.

The outflow channel 124 can merge into a first ventilation channel 130.

According to FIG. 1, the ventilation channel 130 is formed with a first opening 132 and a second opening 136.

Alternatively, the first ventilation channel 130 can be formed with a first opening 132 or a second opening 136.

According to FIG. 1, it is provided that the first and second openings 132; 136 are formed at opposite ends of the first ventilation channel 130.

Alternatively, the first/second opening 132; 136 may be provided along the first ventilation channel.

The first/second openings 132; 136 are formed in combination with a first and second labyrinth element 134; 138, respectively.

The labyrinth elements 134; 138 may represent, in particular, a portion of the fluid connection between the outer side of the ventilation device 100 and the at least one air chamber element 110.

The labyrinth elements 134; 138 can in each case be formed along the first ventilation channel in the region of the first or second opening 132; 136.

In particular, it can be provided according to FIG. 1 that the labyrinth elements 132; 136 are formed in each case as an angled portion or as an angle or as a deflection of 90° along the fluid connection, for providing at least one deflection point.

At least one deflection point, in particular two deflection points, is according to FIG. 1 formed along the fluid connection from an outer side of the ventilation device 100 via the openings 132; 136 into the ventilation channel 130 as far as the outflow portion 120.

Alternatively, it can be provided that the first and/or second labyrinth element 132; 136 each form a plurality of deflection points along the fluid connection, for example a plurality of deflections or angled portions of 90°or in the range of 1 to 90°.

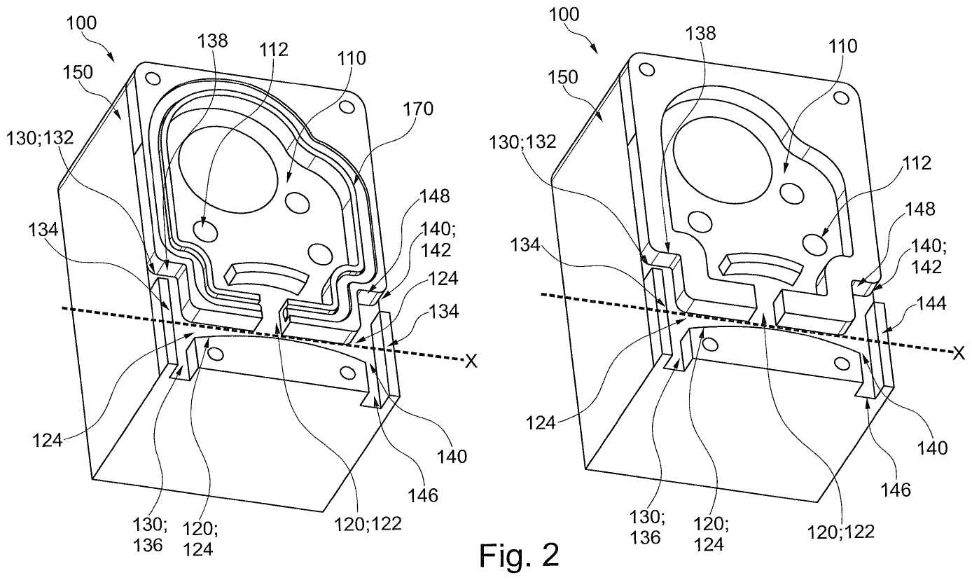

FIG. 2 shows a perspective view of a second exemplary embodiment of a ventilation device 100.

As in the first exemplary embodiment, the second exemplary embodiment of the ventilation device 100 can also be provided as a first side part 150 with the sealing element 170 (see left-hand illustration according to FIG. 2) or without an additional sealing element 170 (see right-hand illustration according to FIG. 2).

The exemplary embodiment of the ventilation device 100 according to the invention shown in FIG. 2 has substantially the same structural and functional features as the first exemplary embodiment of the ventilation device 100 shown in FIG. 1. Hereinafter, the structural and functional differences in features shall primarily be pointed out:

In particular, the second exemplary embodiment according to FIG. 2 has a first ventilation channel 130 and a second ventilation channel 140 compared to the first exemplary embodiment according to FIG. 1.

According to FIG. 2, the outflow portion 120 is formed with an outflow opening 122.

The outflow opening 122 is arranged on a lower side of the air chamber element 110 in the vertical direction and in the direction of action of gravity.

The first outflow channel 124 is arranged or connected to the outflow opening 120.

According to FIG. 2, the outflow channel 124 can run in a horizontal direction.

Furthermore, the outflow channel 124 can have a variable cross-section along the first longitudinal axis X and preferably be formed symmetrically with respect to the outflow opening 122.

The outflow channel 124 forms a fluid connection with the first ventilation channel 130 and also with the second ventilation channel 140.

The first ventilation channel 130 and the second ventilation channel further comprise first and second openings 132; 136; 142; 146.

According to the exemplary embodiment in FIG. 2, the first and second openings 132; 136; 142; 146 are provided at opposite ends of the first/second ventilation channel 130; 140.

Alternatively, the openings 132; 136; 142; 146 may be formed along the first or second ventilation channel 130; 140.

In the region of the first openings 132; 142, the second labyrinth element 138; 148 can in each case be formed.

The first and second ventilation channels 130; 140 are offset at an angle to the outflow channel 124, for example by an angle of approximately 90° according to FIG. 2.

In particular, the first and second ventilation channels 130; 140 can be formed symmetrically to one another in the side part 150.

The second ventilation channel 140 has at least one first and/or second opening 142; 146.

Furthermore, at least one primary labyrinth element 144 for the second ventilation channel 140 is provided.

According to FIG. 2, the second opening 136; 146 of the first and/or second ventilation channel 130; 140 can be formed without a secondary labyrinth element.

Alternatively, a secondary labyrinth element can in each case be arranged or formed in the region of the second opening 136; 146, for example comparably with the exemplary embodiment according to FIG. 1.

The labyrinth elements 134; 138; 144 may for the purposes of the present invention each be provided or be understood as a portion of the fluid connection.

Furthermore, according to FIG. 1 and FIG. 2, additional baffle surfaces can be provided along the fluid connection, for example in the region of the outflow opening 120 within the air chamber unit 110.

The baffle surfaces can be formed as wall portions along the fluid connection or as separate structures, for example within the air chamber unit 110 and facing the outflow opening 122 as a convex surface.

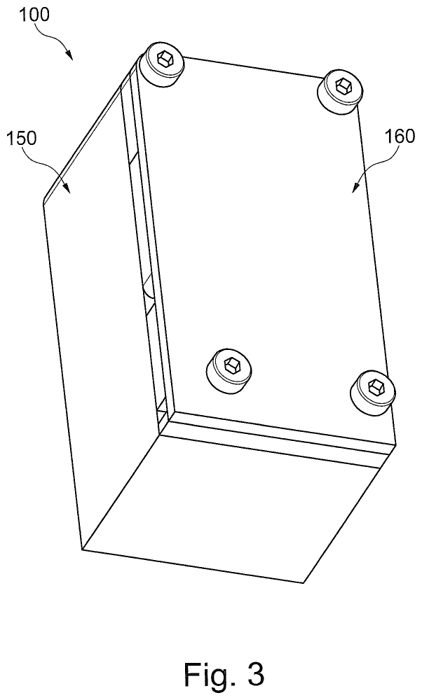

FIG. 3 shows a perspective view of a third exemplary embodiment of a ventilation device 100 according to FIGS. 1 and 2.

As shown in FIG. 3, the first side part 150 of the ventilation device 100 can be closed with a cover element 160. Optionally, a sealing element 170 can be arranged between the cover element 160 and the first side part 150.

Alternatively, a correspondingly designed second side part can be provided in addition to the first side part 150.

The structures of the ventilation device 100, such as the air chamber element 110 and/or the outflow portion 120 and/or the first/second ventilation channels 130; 140, can be formed symmetrically distributed along the surfaces to be arranged relative to one another in the first/second side parts, or can be formed asymmetrically distributed in the first/second side part.

Thus, it is possible that the air chamber element 110 is primarily formed in the first side part 150, wherein the first ventilation channel 130 may be primarily formed in the second side part.

In principle, the function of the ventilation device 100 can be described as follows:

By means of the outflow portion 120 arranged (vertically) at the bottom along the air chamber unit 110, penetrated moisture/liquid can be discharged from the air chamber element 110 in the direction of the gravitational force acting during use as intended.

Furthermore, the arrangement of the outflow portion 120, in particular the outflow opening 122, ensures that liquid can only enter the air chamber element 110 in a vertical direction, wherein the air volume within the air chamber element 110 is compressed.

The structural arrangement of the outflow opening 122 in particular provides protection against the entry of liquid into the air chamber element 110 and can counteract the entry.

The entry of liquid into the air chamber unit 110 can furthermore be counteracted by the formation of an outflow channel 124, in particular in that the outflow channel 124 can be provided in the sense of a rising channel.

Along the openings 132; 136; 142 of the first/second ventilation channels 130; 140, the primary/secondary labyrinth elements 134; 138; 144 can perform a splash guard function, in particular by providing a fluid connection between the outside of the ventilation device 100 and the air chamber element 110 along at least one deflection point.

A deflection point along the fluid connection can prevent a jet of water or the like from directly entering the ventilation device 100 in the longitudinal direction of one of the ventilation channels 130; 140 or from entering the air chamber element 110.

By deflecting or splitting a water jet by means of the labyrinth elements 134; 138; 144 and the ventilation channels 130; 140, an (unhindered) penetration of moisture/liquid into the ventilation device 100 can be at least substantially prevented or counteracted.

In summary, the ventilation device 100 according to the invention can be used to provide advantageous bleeding for preferably a plurality of device units or valves to be ventilated.

In particular, a splash guard function can be provided by means of the labyrinth elements 134; 138; 144, wherein the ventilation unit 100 at least substantially prevents or counteracts the penetration of moisture/liquid, and by means of openings 132; 136; 142; 146 of the ventilation channels 130; 140, a drainage of penetrated moisture/liquid can be facilitated or promoted or supported.

Furthermore, the outflow portion 120 can be formed with an outflow opening 122, in particular in combination with an outflow channel 124, in order to counteract a rise of moisture/liquid into the (common) air chamber element 110 of the preferably plurality of device units/valves to be ventilated.

### LIST OF REFERENCE SIGNS

100 ventilation device
110 air chamber element
112 ventilation region
120 outflow portion
122 outflow opening
124 outflow channel
130 first ventilation channel
132 first opening
134 primary labyrinth element
136 second opening
138 secondary labyrinth element
140 second ventilation channel
142 third opening
144 primary labyrinth element
146 fourth opening
150 first side part
160 cover element
170 sealing element
A spacing
B spacing
X first longitudinal axis

1.-10. (canceled)

11. A ventilation device for use with at least one valve unit or a plurality of valve units, comprising:
an air chamber element;
an outflow section; and
a first ventilation channel for forming a fluid connection between an outer side of the ventilation device and the air chamber element,
wherein the outflow section provides the fluid connection between the air chamber element and the first ventilation channel and is formed at least partially in the form of a riser channel,
wherein the first ventilation channel has a first and/or a second opening,
wherein the first ventilation channel comprises a primary labyrinth element and/or a secondary labyrinth element, and
wherein the primary and/or secondary labyrinth element are/is provided such that, in each case, at least one deflection point is formed along the fluid connection between the outer side of the ventilation device and the air chamber element.

12. The ventilation device as claimed in claim 11, wherein
the first ventilation channel opens into the outflow section along its first and/or second opening and the first and/or second labyrinth element.

13. The ventilation device as claimed in claim 12, wherein
the first ventilation channel opens into the outflow portion along the first opening and the first and also second labyrinth element and/or along the second opening and also the first labyrinth element and/or second labyrinth element.

14. The ventilation device as claimed in claim 11, further comprising:
a second ventilation channel provided with a first and/or second opening,
wherein the first and second ventilation channels are arranged on opposite end sides of the outflow section, and
wherein the second ventilation channel comprises a primary and/or a secondary labyrinth element.

15. The ventilation device as claimed in claim 14, wherein
the primary and/or secondary labyrinth element in each case forms at least one deflection point along the fluid connection between the outer side of the ventilation device and the air chamber element.

16. The ventilation device as claimed in claim 11, wherein
the ventilation device is designed with a first side part and a cover element or with corresponding first and second side parts and a sealing element arranged between the first and second side parts.

17. The ventilation device as claimed in claim 11, wherein
the outflow section is formed at a lower end of the air chamber element in a vertical direction.

18. The ventilation device as claimed in claim 11, wherein
the outflow section is formed as at least one outflow opening or as at least one outflow opening in combination with at least one outflow channel, for providing the fluid connection between the air chamber element and the first ventilation channel.

19. The ventilation device as claimed in claim 11, wherein
the ventilation device is designed to receive and ventilate a plurality of valves in fluid connection with the air chamber element,
wherein a ventilation region is formed for each of the plurality of valves along the air chamber element.

20. The ventilation device as claimed in claim 19, wherein
the outflow section is provided with at least one outflow channel and at least one outflow opening, for forming a fluid connection between the outflow channel and the air chamber element,
wherein the air chamber element is formed with at least one ventilation region,
wherein a vertical spacing between an access region of the outflow opening on a side of the outflow opening remote from the air chamber element, and an access region of the outflow channel of the access point situated furthest away on a side of the outflow channel remote from the air chamber element, is smaller than a vertical spacing between an access region of the outflow opening on a side of the outflow opening remote from the air chamber element and a closest ventilation region.

21. A brake system for trucks comprising at least one ventilation device as claimed in claim 11.
